(19) United States
(12) Patent Application Publication
(10) Pub. No.: US 2024/0209909 A1
(43) Pub. Date: Jun. 27, 2024

(54) BALL SCREW DRIVE, METHOD FOR PRODUCING A BALL SCREW DRIVE AND ACTUATOR ASSEMBLY HAVING A BALL SCREW DRIVE

(71) Applicant: ZF Active Safety GmbH, Koblenz (DE)

(72) Inventor: Volker Knop, Ulmen (DE)

(21) Appl. No.: 18/533,572

(22) Filed: Dec. 8, 2023

(30) Foreign Application Priority Data
Dec. 21, 2022 (DE) 102022134385.5

(51) Int. Cl. F16D 65/46; B60T 11/04

(52) U.S. Cl. CPC F16D 65/46; B60T 11/04; F16D 2125/40

(57) ABSTRACT

An actuator assembly has a ball screw drive, having a ball screw spindle rotatably mounted about a spindle axis and on which a spindle nut is received, wherein at least one thread track is formed on an outer circumferential surface of the ball screw spindle, which track extends over less than 360° of the circumference of the ball screw spindle. A ball return is arranged on the outer circumferential surface for each thread track and connects a beginning and an end of the thread track to one another. A ball race for the balls is formed in a separate insert, which is inserted into a depression arranged in the outer circumferential surface. To produce the ball screw spindle, a thread is introduced into the outer circumferential surface of the ball screw spindle and at least one depression is introduced into the outer circumferential surface. The depression defines the beginning and end of a thread track. The insert is inserted into the depression in such a way that its ball race adjoins the beginning and the end of the thread track.

### CROSS-REFERENCE TO RELATED APPLICATION

This application claims priority to German Priority Application No. 102022134385.5, filed Dec. 21, 2022, the disclosure of which is incorporated herein by reference in its entirety.

### TECHNICAL FIELD

The disclosure relates to a ball screw drive for an actuator assembly of an electromechanically actuated vehicle brake. The disclosure also relates to a method for producing a ball screw spindle of a ball screw drive and to an actuator assembly having a ball screw drive.

### BACKGROUND

Ball screw drives comprise a ball screw spindle and a spindle nut, wherein a multiplicity of balls is accommodated between a thread track of the ball screw spindle and a continuous thread in the spindle nut. Owing to the rotation of the ball screw spindle or the spindle nut, the balls are transported to one of the ends of the thread track. From there, they are returned to the other end of the thread track via a ball return. The ball return connects the beginning and end of the thread track, and therefore the balls pass through a closed curve in an endless loop.

In ball screw drives with a spindle nut open on both sides, it is known to arrange the ball return in the spindle nut. By gradually inserting a cylindrical rod into the spindle nut, the balls can be installed in the thread grooves of the latter and in the ball return. The balls are secured in the spindle nut against falling out by the cylindrical rod. The ball screw spindle is then screwed into one end of the spindle nut and, in the process, the cylindrical rod is pushed out of the nut at the other end.

However, if, for example, a spindle nut closed on one side is to be used, assembly in the manner described above is not possible since the rod serving as an assembly aid cannot be pushed out by inserting the ball screw spindle into the spindle nut. In conventional ball screw drives, pre-mounting of the balls on the ball screw spindle is also not possible since in this case a ball return in the spindle nut cannot be filled with balls.

In addition, a ball return on the spindle nut often increases the installation space required.

### SUMMARY

What is needed is an improved ball screw drive which, in particular, enables the use of a spindle nut closed on one side. In addition, the aim is to simplify a method for producing a ball screw spindle.

A ball screw drive is disclosed, which has a ball screw spindle rotatably mounted about a spindle axis, on which a spindle nut is received, wherein at least one thread track is formed on an outer circumferential surface of the ball screw spindle, which track extends over less than 360° of the circumference of the ball screw spindle and in which a multiplicity of balls is guided in such a way that a rotation of the ball screw spindle causes an axial movement of the spindle nut along the spindle axis, wherein the ball screw spindle has a ball return for each thread track on the outer circumferential surface, which ball return connects a beginning and an end of the thread track to one another. A ball race for the balls in the ball return is formed in a separate insert, which is inserted into a depression arranged in the outer circumferential surface.

The ball return and the ball race can both be formed completely in the insert. Since the insert is produced as a separate component, it is possible to dispense with complex machining of the ball screw spindle to produce the ball race. Nevertheless, the ball race can be optimally adapted geometrically with regard to frictional forces and noise.

The shape of the depression must only be designed for the outer contour of the insert, but not for the shape of the ball race. The depression is used only to receive the insert and not to shape the ball race. Therefore, the geometry of the depression can be selected in such a way that the depression can be produced easily and at low cost.

As described above, the spindle nut normally has, on its inside, a thread matched to the thread track in the ball screw spindle, the said thread having a single, continuous thread groove.

When, during a rotation of the ball screw spindle, a ball has arrived at the end of the thread track, the ball is pushed by the following balls into the ball race of the insert during further rotation of the ball screw spindle, and is transported from there back to the beginning of its thread track. Whether the balls pass through the ball return from the end of the thread track to its beginning or vice versa depends, of course, on the direction of rotation of the ball screw spindle. For reasons of clarity, only one direction of rotation is considered here in each case.

In one exemplary arrangement, a plurality of separate thread tracks is formed in the outer circumferential surface of the ball screw spindle, the end and beginning of which tracks are each connected via a separate ball return to a single, separate insert. The thread tracks are arranged axially in succession along the spindle axis in the outer circumferential surface of the ball screw spindle. Four thread grooves can be provided, for example.

The depression which receives the insert may be of elongate design, and an outer contour of the insert is matched to an inner contour of the depression. Inter alia, this provides protection against incorrect installation of the insert.

The depression and the insert can have a simple geometric outer contour, making manufacture easier. For example, the depression and thus also the insert can have an oval outer contour with two parallel longitudinal side faces.

The ball race, on the other hand, can have a complex, even three-dimensionally curved profile. An insert of this kind can be manufactured at low cost as a separate component.

The depression is aligned obliquely to the thread track to provide a simple way of connecting the beginning and end of the respective thread track.

The ball race runs in an S shape along the longitudinal extent of the insert. For example, the ball race is curved at a first and a second end of the ball race and is of rectilinear design in a central portion therebetween. In this way, the balls are deflected transversely to the thread track only in the ball race. It is thus possible to achieve guidance of the balls with the largest possible radii, which reduces friction forces between the balls and the ball race and reduces noise.

The course of the ball race at the first and at the second end of the ball race is the product of a pitch of the thread track with respect to the spindle axis and an oblique position of the longitudinal direction of the insert with respect to the spindle axis. It is advantageously selected in such a way that the first and the second end of the ball race adjoin the beginning and end of the thread track continuously at a 180° angle.

The ball race is open to the outside.

Perpendicularly to a radial direction and towards the spindle axis, the ball race runs in an arcuately curved manner. The curvature can be provided continuously over the entire course of the ball race. By virtue of the curvature, the ball race is lower than the thread track. As a result, the ball race is designed in such a way that, as they pass through the ball return, the balls pass underneath thread webs of the spindle nut that are in the way and are thus not prevented by the thread of the spindle nut from getting back from the end to the beginning of their thread track.

The ball race has no edges or steps, but is shaped with a continuous curvature, thus ensuring that the balls are uniformly deflected and guided.

The depressions and thus also the inserts are distributed uniformly over the circumference of the ball screw spindle in order to make the best possible use of the available installation space on the outer circumferential surface of the ball screw spindle.

In one exemplary arrangement, the insert is an injection-moulded component, a die-cast component or a sintered component. This enables the insert to be produced in a simple manner as a solid component with a suitably curved ball race. The ball race is moulded directly into the insert during manufacture.

The insert can be produced from a suitable plastic, a suitable metal or a suitable ceramic material. When a plastic is used, the material of the insert can also additionally contribute to noise damping.

In addition, a method for producing a ball screw spindle of a ball screw drive of the kind described above is disclosed, which comprises the following steps:
introducing a thread into the outer circumferential surface of the ball screw spindle,
introducing at least one depression into the outer circumferential surface, wherein the depression defines the beginning and the end of a thread track; and
inserting the insert into the depression, such that its ball race adjoins the beginning and the end of the thread track.

The thread can be produced by rolling, for example, and can extend, in particular, over the entire outer circumferential surface of the ball screw spindle.

The depression intersects the thread and thus defines the beginning and end of the thread track. The thread track is thus formed by a portion of the thread. The only thing necessary to define all thread tracks is to produce the thread and introduce the corresponding number of depressions, making manufacture simpler.

The inserts are firmly fixed in the depressions, for example by positive engagement, nonpositive engagement and/or an adhesive connection.

The depression can, for example, be introduced into the outer circumferential surface by a cutting tool guided in a radial direction of the ball screw spindle and perpendicularly thereto. The side faces of the depression can be aligned parallel to the radial direction. Such a depression can be produced easily, for example by milling. It is thereby possible to eliminate further complex machining operations.

The initially introduced thread is a continuous thread comprising a plurality of thread grooves, which is subdivided into a plurality of mutually separate thread tracks by the introduction of at least one depression, wherein the insert is then inserted into the at least one depression.

In addition, an actuator assembly having a ball screw drive of the kind described above is disclosed, wherein the spindle nut is of closed design on one side.

Since the ball return is arranged completely in the recirculating ball nut, the balls can be introduced without problems into the thread groove and into the ball return, even if the spindle nut is closed at one end.

However, the ball screw drive can also be implemented with a spindle nut that is open on both sides.

Moreover, the ball return integrated into the ball screw spindle allows a compact design of the ball screw drive.

The actuator assembly is part of a vehicle brake, wherein the spindle nut forms a brake piston. That is to say that the spindle nut is used to apply a friction pad to a brake rotor of the vehicle brake.

### BRIEF DESCRIPTION OF DRAWINGS

The disclosure will be described hereinafter in greater detail on the basis of an exemplary arrangement with reference to the accompanying figures. In the figures:

FIG. 1 shows a schematic perspective illustration of an actuator assembly according to the disclosure having a ball screw drive according to the disclosure;

FIG. 2 shows a schematic sectional view of the actuator assembly from FIG. 1;

FIG. 3 shows a schematic illustration of the ball screw drive according to the disclosure;

FIG. 4 shows a schematic perspective illustration of the screw drive from FIG. 3, in which a ball screw spindle and a spindle nut are illustrated separately from one another;

FIG. 5 shows the ball screw spindle, produced by a method according to the disclosure, from FIG. 3 in an exploded view;

FIG. 6 shows a schematic perspective illustration of an insert of the ball screw drive from FIG. 3; and

FIG. 7 shows a schematic sectional view through the ball screw drive according to the disclosure along the line VII-VII in FIG. 3.

For reasons of clarity, all identical components are not always provided with reference signs.

### DETAILED DESCRIPTION

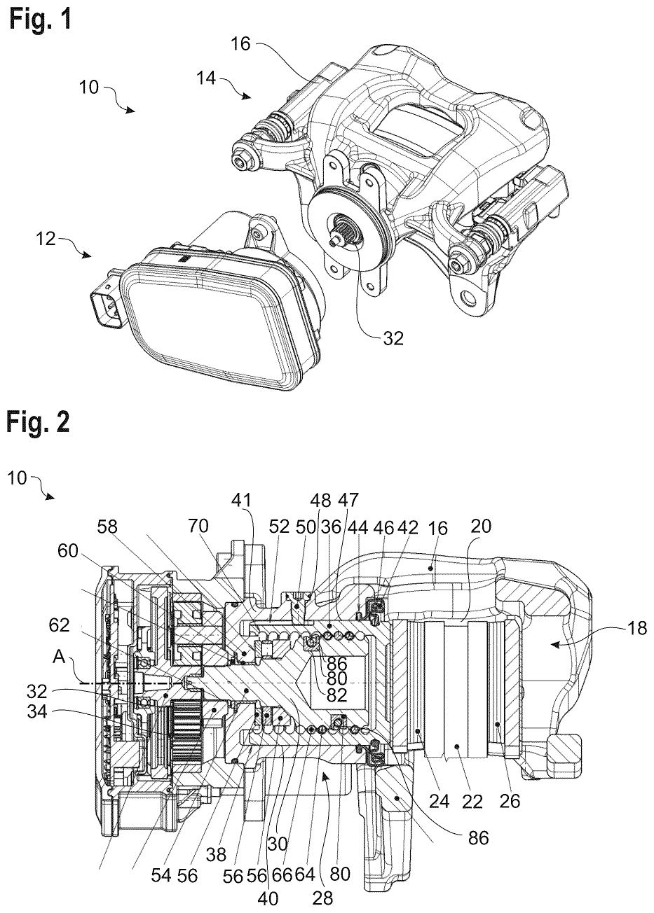

FIGS. 1 and 2 show an actuator assembly 10 for a vehicle brake.

The actuator assembly 10 comprises a control assembly 12, which can be installed as a separate sub-unit, and a drive and brake assembly 14, which can be installed as a separate sub-unit. The drive and brake assembly 14 is accommodated in a common housing 16.

A housing of the control assembly 12 is connected to the housing 16. Here, both housings are produced from a plastic material.

The drive and brake assembly 14 includes a brake caliper 18, in which a space 20 for a brake rotor 22, i.e. a brake disc, is formed. The brake rotor 22 interacts with two friction pads 24, 26, which can be pressed against the brake rotor 22 to produce a braking effect.

The pressing force for closing the brake is produced by a ball screw drive 28.

The ball screw drive 28 described can, of course, also be used in other areas of application in which ball screw drives are conventionally used.

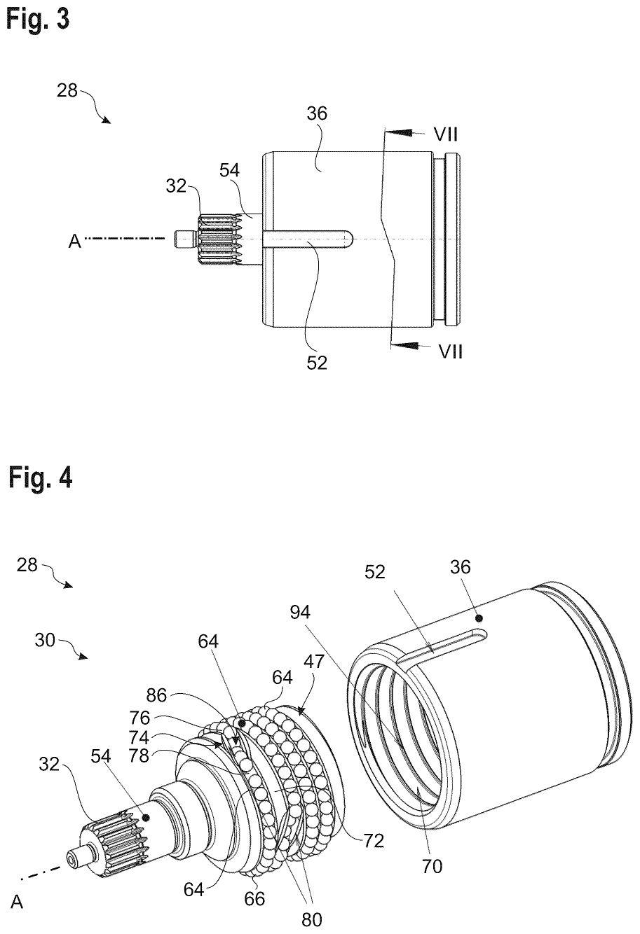

This comprises a ball screw spindle 30 rotatably mounted about a spindle axis A (see also FIGS. 3 to 7).

In this case, the ball screw spindle 30 is connected via a toothed portion 32 to a transmission thread 34 (not illustrated specifically) and, via the latter, to an electric motor (not illustrated). Thus, the ball screw spindle 30 can be driven by the electric motor and moved in both directions of rotation.

A spindle nut 36 closed axially on one side, which is designed as a piston-shaped brake piston, is mounted on the ball screw spindle 30.

A rotation of the ball screw spindle 30 causes an axial movement of the spindle nut 36 along the spindle axis A.

In this case, the spindle nut 36 is guided along the spindle axis A directly on a running surface 38.

The spindle nut 36 is used to apply the friction pads 24, 26 to the brake rotor 22. To be more precise, the friction pad 24 can be actively moved towards the brake rotor 22 by the actuator assembly 10. Here, the friction pad 24 is contacted directly by an end face of the spindle nut 36.

It is clear that the spindle nut 36 can be moved in the same way, by operating the electric motor, into a retracted position which is assigned to lifting the brake pads 24, 26 from the brake rotor 22.

In the present case, the actuator assembly 10 is embodied without self-locking and therefore, because of system-inherent elasticities, the spindle nut 36 also automatically moves back into the retracted position when no longer actively loaded into the extended position by the electric motor.

The running surface 38 defines a substantially cylindrical receiving space 40 for the ball screw drive 28 in a brake housing cylinder 41. A seal 42, here made of an elastomer, is provided at the transition from the space 20 to the receiving space 40.

The seal 42 is formed as a bellows and held not only on the brake caliper 18 but also on the spindle nut 36, with the result that the seal 42 is expanded or compressed when the spindle nut 36 moves. For this purpose, ends of the seal 42 which are thickened in the form of beads are engaged in grooves 44, 46 in the brake caliper 18 and in an outer circumferential surface 47 of the spindle nut 36.

Furthermore, an aperture 48 is provided in the brake caliper 18 in the region of the running surface 38. A rotational locking element 50 is inserted in the aperture 48 and protrudes through the aperture 48 to engage in an axially running groove 52 on the outer circumferential surface 47 of the spindle nut 36.

In the exemplary arrangement, the rotational locking element 50 is a screw which is screwed into a threaded bore forming the opening 48.

The reaction force of the axial force or brake application force produced by the ball screw drive 28 is transmitted by a spindle shaft 54 via axial rolling bearing elements 56 and is supported on the housing.

Here, the axial rolling bearing elements 56 includes a planar axial bearing ring disc, an axial rolling bearing and a bearing ring. The axial rolling bearing is optionally embodied as an axial cylindrical roller bearing or as a single-row or multi-row axial needle bearing and is centred on the spindle shaft 54. The bearing ring has a planar contact surface on one side and a concave contact surface on the opposite side. With its concave contact surface, the bearing ring is in engagement with a convex contact geometry applied to the spindle shaft 54. The rolling elements of the axial rolling bearing roll on the planar contact surfaces of the axial ring disc and the bearing ring.

In the initial position of the spindle nut 36, i.e. when the friction pads 24, 26 have a full pad thickness and the brake rotor 22 has a full disc thickness, the axial rolling bearing elements 56 are positioned centrally within the spindle nut 36 in the axial direction. For this purpose, a bottom of the brake housing cylinder 41 is embodied as a raised plateau 58.

Here, the spindle shaft 54 is supported radially at the free end in the brake housing cylinder 41 with the aid of the radial plain bearing 60. The radial plain bearing 60 is pressed into the wall of the bottom of the brake housing cylinder 41 from the outside. A collar of the radial plain bearing 60 contacts the bottom of the brake housing cylinder 41. Axial forces that act on the spindle shaft 54 during the reduction of the brake application force and the retraction of the spindle nut 36 are supported on the collar of the radial plain bearing 60. For this purpose, a retaining ring 62 is snapped into a groove in the spindle shaft 54. As a result, the retaining ring 62 is able to transmit axial forces of the spindle shaft 54.

In this example, the spindle shaft 54 is hollowed out at its end directed towards the caliper 18 for weight-reducing reasons.

The ball screw drive 28 is described in more detail below in conjunction with FIGS. 3 to 7.

On the outer circumferential surface 47 of the ball screw spindle 30, a plurality of mutually separate thread tracks 64, in this case four thereof, is formed, in each of which a multiplicity of balls 66 is guided.

Each thread track 64 comprises a turn through less than 360° of a thread 72 formed on the outer circumferential surface 47 of the ball screw spindle 30.

A continuous thread 70 with an identical pitch to that of the thread tracks 64 is formed on an inner circumferential surface of the spindle nut 36.

Here, the threads 70, 72 are designed as a circular arc or as a gothic ogival arc in profile section.

The balls 66 are each accommodated between their thread track 64 on the ball screw spindle 30 and the thread 70 on the spindle nut 36. A rotation of the ball screw spindle 28 causes an axial movement of the spindle nut 36 along the spindle axis A, which coincides with the axis of rotation of the ball screw spindle 28. Here, the direction of rotation of the ball screw spindle 30 determines the direction of movement of the balls 66 in the respective thread track 64 and also the direction of movement of the spindle nut 36. The balls 66 are arranged in a sequential series on the thread track 64.

The osculation factor, i.e. the ratio of a radius of the thread track 64 to the diameter of the balls 66, is between 0.52 and 0.55 here.

Each thread track 64 is closed by a ball return 74 to form an endless track. Owing to the rotation of the ball screw spindle 30, the balls 66 move from a beginning 76 to an end 78 of their thread track 64 and from there through the ball return 74 back to the beginning 76 (see, for example, FIG. 4). The beginning 76 and end 78 of the thread track 64 are, of course, dependent on the direction of rotation of the ball screw spindle 30 and therefore swap over when the direction of rotation changes.

Adjacent balls 66 are in contact over the entire path that they traverse. Balls 66 that enter the ball return 74 from the thread track 64 push the balls 66 that are already in the ball return 74 through the latter, ensuring that the balls 66 are returned to the beginning 76 of their thread track 64. Upon entry of a ball 66 into the ball return 74, the ball 66 is removed from the flow of force and returns to the flow of force upon exit from the ball return 74.

If the ball screw spindle 30 rotates in the opposite direction, the movement naturally takes place in the opposite direction from the end 78 to the beginning 76 and from there into the ball return 74.

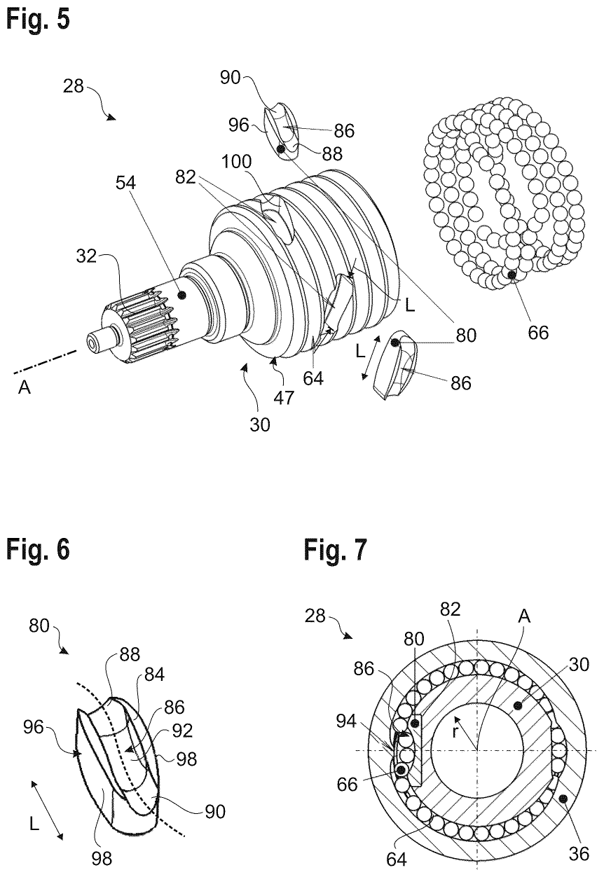

The ball return 74 is formed entirely in an insert 80. The insert 80 is inserted into a precisely fitting depression 82 in the outer circumferential surface 47 of the ball screw spindle 30 (see FIGS. 5 and 7) and firmly fixed there.

The depression 82 and accordingly also the insert 80 are of elongate design along a longitudinal direction L. The depression 82 is aligned with its longitudinal direction L oblique to the thread track 64, such that it is positioned adjacent to the beginning 76 and the end 78 of a thread track 64.

In the insert 80, more precisely on a surface 84 of the insert 80, an outwardly open ball race 86 is formed, which runs continuously from a first end 88 to a second end 90.

The insert 80 is inserted into the depression 82 in such a way that the first end 88 of the ball race 86 is directly adjacent to the beginning 76, and the second end 90 is directly adjacent to the end of the thread track 64. The balls 66 thus pass from the end 78 of the thread track 64 into the ball race 86 and, after passing through the ball return 74, back to the beginning 76 of the thread track 64.

In this case, the ball race 86 is curved in an s shape, wherein it runs in a curved manner in the region of the first end 88 and in the region of the second end 90, while a central portion 92 is designed to run in a straight line in this case. The curvatures are each selected in such a way that the ball race 86 adjoins the beginning 76 and the end 78 of the thread track 64 in a straight line, i.e. at a 180° angle, at the first end 88 and at the second end 90. The balls 66 are thus deflected continuously out of the thread track 64 into the ball race 86 and from the latter back into the thread track 64.

Moreover, viewed perpendicularly to the radial direction r, the ball race 86 runs in an arcuately curved manner towards the spindle axis A. The ball race 86 is therefore recessed with respect to the thread track 64 and the outer circumferential surface 47. This ensures that the balls 66 in the ball race 86 pass under a web 94 of the thread 70 of the spindle nut 36 without contact therewith, which web would otherwise prevent the balls 66 from being returned to the beginning 76 of the thread track 64. This is also illustrated in FIG. 7.

The path that the balls 66 take through the ball race 86 is indicated by dashed lines in FIG. 6.

The depression 82 and the inserts 80 of the different thread tracks 64 are distributed uniformly along the circumference of the ball screw spindle 30 (see, for example, FIGS. 4 and 5).

To produce the ball screw spindle 30, the thread 72 is first introduced continuously in the outer circumferential surface 47 from an end close to the spindle shaft to an end of the outer circumferential surface 47 close to the brake caliper.

This thread 72 is subdivided into the desired number of thread tracks 64 by introducing one or more depressions 82 into the outer circumferential surface 47, wherein each thread track 64 begins at a depression 82 and ends at the same depression 82 after one revolution through not quite 360°.

An insert 80 is inserted into each depression 82, such that its ball race 86 is directly adjacent to the beginning 76 and the end 78 of the respective thread track 64. All inserts 80 are identically shaped.

The insert 80 is fixed in the depression 82 by positive engagement, nonpositive engagement and/or an adhesive connection, for example.

An outer contour 96, for example, the side faces of the insert 80, has/have a simple geometry. An oval with parallel longitudinal side faces 98 is selected here. Accordingly, an inner contour 100 of the depression 82 also has the same simple geometry. The portions of the inner contour 100 which correspond to the longitudinal side faces 98 here extend completely parallel to the radial direction r.

The depression 82 is introduced into the circumferential surface by, for example, a cutting tool, which is guided only in the radial direction r and perpendicularly thereto.

Here, the insert 80 is manufactured as an injection-moulded component, as a die-cast component or as a sintered component, wherein the ball race 86 is introduced during the manufacturing process by the shaping of the insert 80 by a corresponding tool mould. The ball race 86 can therefore have a complex shape which is matched to the respectively desired course of the thread track 64.

1. A ball screw drive, comprising a ball screw spindle rotatably mounted about a spindle axis, on which a spindle nut is received, wherein at least one thread track is formed on an outer circumferential surface of the ball screw spindle, which track extends over less than 360° of a circumference of the ball screw spindle, and in which a multiplicity of balls is guided in such a way that a rotation of the ball screw spindle causes an axial movement of the spindle nut along the spindle axis, wherein the ball screw spindle has a ball return for each thread track on the outer circumferential surface, which ball return connects a beginning and an end of the thread track to one another, and wherein a ball race for the balls in the ball return is formed in a separate insert, which is inserted into a depression arranged in the outer circumferential surface.

2. The ball screw drive according to claim 1, wherein the depression is of elongate design, and an outer contour of the insert is matched to an inner contour of the depression.

3. The ball screw drive according to claim 2, wherein the depression is aligned obliquely to the thread track.

4. The ball screw drive according to claim 1, wherein the ball race runs in an S shape along the longitudinal extent of the insert.

5. The ball screw drive according claim 1, wherein the ball race runs in an arcuately curved manner perpendicularly to the radial direction and towards the spindle axis.

6. The ball screw drive according to claim 1, wherein the depressions are distributed uniformly over the circumference of the ball screw spindle.

7. The ball screw drive according to claim 1, wherein the insert is an injection-moulded component, a die-cast component or a sintered component.

8. A method for producing a ball screw spindle of a ball screw drive, comprising the following steps:
introducing a thread into an outer circumferential surface of a ball screw spindle,
introducing at least one depression into the outer circumferential surface, wherein a depression defines a beginning and an end of a thread track; and
inserting an insert into the depression, such that its ball race adjoins the beginning and the end of the thread track.

9. The method according to claim 8, wherein the depression is introduced into the outer circumferential surface by a cutting tool guided in a radial direction of the ball screw spindle and perpendicularly thereto.

10. The method according to claim 8, wherein the initially introduced thread is a continuous thread comprising a plurality of thread grooves, which is subdivided into a plurality of mutually separate thread tracks by introduction of at least one depression, and wherein the insert is then inserted into the at least one depression.

11. An actuator assembly having a ball screw drive according to claim 1.

12. Actuator assembly (10) according to claim 11, wherein the actuator assembly (10) is part of a vehicle brake and the spindle nut (36) forms a brake piston.

13. The ball screw drive according to claim 2, wherein the ball race runs in an S shape along the longitudinal extent of the insert.

14. The ball screw drive according claim 2, wherein the ball race runs in an arcuately curved manner perpendicularly to the radial direction and towards the spindle axis.

15. The ball screw drive according to claim 2, wherein the depressions are distributed uniformly over the circumference of the ball screw spindle.

16. The ball screw drive according to claim 15, wherein the insert is an injection-moulded component, a die-cast component or a sintered component.

17. The method according to claim 9, wherein the initially introduced thread is a continuous thread comprising a plurality of thread grooves, which is subdivided into a plurality of mutually separate thread tracks by introduction of at least one depression, and wherein the insert is then inserted into the at least one depression.
